(19) United States
(12) Patent Application Publication
(10) Pub. No.: US 2003/0043368 A1
(43) Pub. Date: Mar. 6, 2003

(54) Refraction chamber

(76) Inventors: John W. Gunyon, Abilene, TX (US); Jessie Singh, Abilene, TX (US); Rimi Singh, Abilene, TX (US); Kevin Randolph, Abilene, TX (US); Gary L. Workman, Madison, AL (US); G. Wayne Thompson, Huntsville, AL (US); David B. Purves, Madison, AL (US)

Correspondence Address: DANIEL V. THOMPSON, 9330 LBJ FWY., SUITE 1185, DALLAS, TX, 75243, US

(21) Appl. No.: 09/682,458

(22) Filed: Sep. 5, 2001

(51) Int. Cl. G01N 21/41

(52) U.S. Cl. 356/128

(57) ABSTRACT

A method and apparatus for fluid analysis includes a sensor for determining the index of refraction of a fluid. Advanced methods of fluid analysis relate index of refraction and other measured physical characteristics of the fluid.

### BACKGROUND OF INVENTION

The present invention relates to measuring instruments, and more particularly to devices for analyzing fluids using measurements of index of refraction and other physical characteristics.

Refrigerant gases containing chlorine, for example difluorodichloromethane (known as “R12”), have been phased out of use in new refrigeration systems for their harmful effects on the environment. Tight regulatory controls have been imposed governing the reuse and reclamation of such refrigerants.

A device and method for refrigerant analysis is disclosed in our U.S. Pat. No. 5,870,185, the disclosure of which is incorporated herein by reference. The apparatus of U.S. Pat. No. 5,870,185 has been found to be particularly useful in analyzing refrigerant samples by determining index of refraction along with other physical parameters. A fluid sample is introduced into a sample chamber, then a laser is shown through the fluid in chamber and out a glass window into transparent positioner. The angle of the laser in the positioner as it exits the chamber through the window is directly related to the index of refraction.

Our prior device's characterization of transparent fluids is based on the physical property of refractive index, correlated to temperature and pressure. By using these three variables, the microprocessing and physical sampling apparatus characterizes refrigerants and discriminates them from one another to within EPA standards of 0.5% of pure.

Refrigerants (R-12, R-22, R134a, R-113, R-114, R-115, R-11, R-13, R-123, R-152a) are indexed and classified to 99.5% and to within 2% in binary mixtures such as 500,501,502 and all of the new 400 series. The current instrument can characterize any fluid, which is transparent, with refractive index (RI) in the range from 1.15000 to 1.4000+/−0.00002 and vapor pressure up to 350 Psia.

The device can be programmed to be used as the discriminator between specific chemical groups, such as refrigerant analysis (pure and binary) or chemical characterization online in a chemical production facility. Online applications typically require a flow-through cell sampling technique. A computer, communicating via an existing RS232 port, would then query the analyzer at specified intervals to assess the current purity or status of the material in question. From this point, process functions can, be modified, automatically stopped, or reported in a variety of ways.

The technology incorporated into the instrument for making refractive index measurement is extremely reliable since it requires no moving parts. Utilization of a laser light source and photo diode array provides an extremely accurate RI measurement and allows the instrument to obtain a resolution of 0.00002 RI units using advanced digital processing of the refracted beam. This technology, with an upward shift in the RI measurements, can also achieve an even larger cross-section of chemical processing capabilities. Identification of contamination levels, by monitoring changes, can reduce equipment downtime and increase the life of a system.

Identifying and properly handling refrigerants is a major concern and the meeting of EPA standards and regulations is required. The device analyzes liquid refrigerant rather than vapor/gas samples and eliminates errors caused by other NDIR methods. The instrument is designed with optic refractometry using high-speed microprocessors. Despite the complexity of blended gases, which have challenged the refrigerant industry for years, the device and method of the prior patent are easy-to-use and provide the analysis in seconds. Experience has shown, however, that the physical construction of the refraction chamber shown in U.S. Pat. No. 5,870,185 is less than optimal. Potential problems with leakage, glass breakage, and gasket swelling have presented needs to be addressed. In particular, it has been found that it is difficult to manufacture a chamber with machining tolerances tight enough to seal the chamber yet loose enough to not break the glass window of the chamber. In addition, conventional gasketing materials tend to swell and block the laser beam.

### BRIEF DESCRIPTION OF DRAWINGS

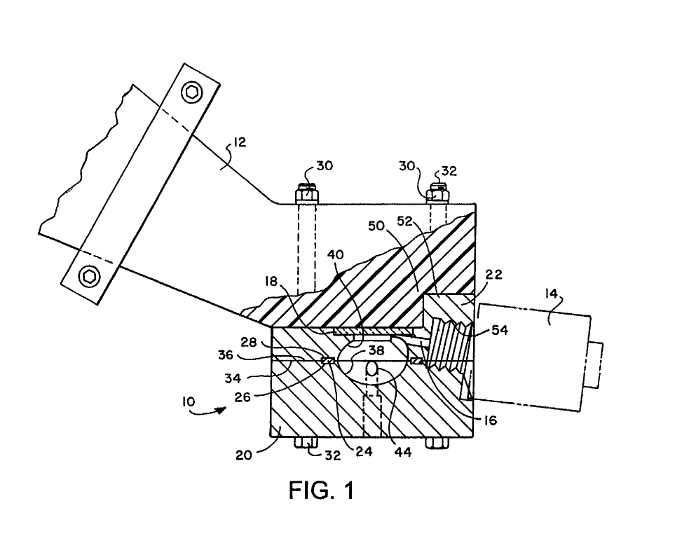

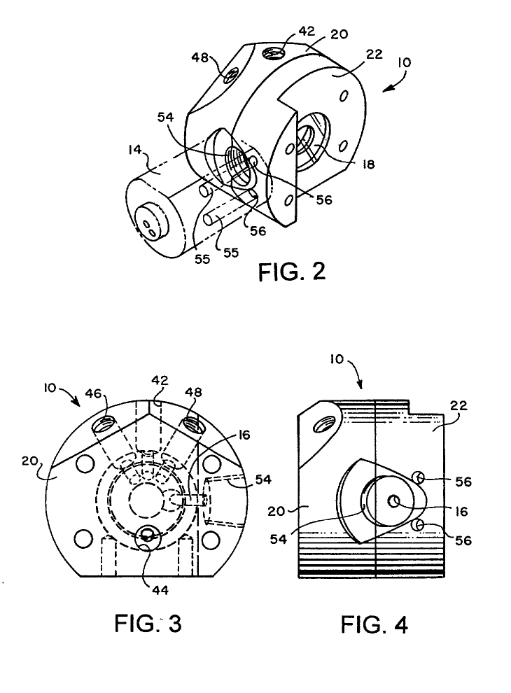

A more complete understanding of the invention and its advantages will be apparent from a review of the Detailed Description in conjunction with the following Drawings, in which: FIG. 1 is a partially broken away top view of the improved refraction chamber of the present invention; FIG. 2 is perspective view of the refraction chamber; FIG. 3 is an end view of the refraction chamber; and FIG. 4 is a side view of the refraction chamber.

### DETAILED DESCRIPTION

Referring initially to FIGS. 1-4, where like reference numerals indicate like and corresponding elements, a refraction chamber 10 is fitted to a transparent positioner 12. Laser 14 is fixed to one side of chamber 10, positioned to direct a beam into the chamber through passage 16 and out of the chamber through window 18. As described in U.S. Pat. No. 5,870,185, a photo diode array (not shown) is fixed to the far end (not shown) of transparent positioner 12.

Chamber 10 is formed of two mating sections, outer section 20 and inner section 22. Outer and inner sections 20, 22 are sealed by a gasket ring 24. Outer and inner sections 20, 22 are preferably machined from aluminum, and gasket ring 24 is a polytetrafluoroethylene (Teflon®) material. Gasket ring 24 has rectangular cross-sections, with the height of the cross section about a third of the width. (height-width ratio 1:3). Gasket ring 24 is trapped in mating, rectangular grooves 26, 28 on opposite sides of outer and inner sections 20, 22. When fasteners 30 on through bolts 32 are tightened, faces 34, 36 of outer and inner sections 20, 22, respectively, meet to capture and compress gasket ring 24, thereby sealing sections 20, 22 and preventing the gasket ring 24 from extruding into the chamber and from blocking the laser.

Semi-hemispherical inner surfaces 38, 40 are machined in outer and inner sections 20, 22, respectively, to form a void into which a sample fluid may be drawn and expelled though inlet 42 and outlet 44. Inlet 42 and outlet 44 are at a right angle to each other, to improve flow and avoid impingement on window 18. Ports 46, 48 are provided in outer section 20 to permit mounting of pressure and temperature transducers (not shown).

Transparent positioner 12 and inner section 22 have complementary steps 50, 52 to improve the geometry of the device.

Laser 14 may be mounted using pipe thread 54 or cylindrical pins 55 in mating holes 56.

Whereas, the present invention has been described with the respect to a specific embodiment thereof, it will be understood that various changes and modifications will be suggested to one skilled in the art, and it is intended to encompass such changes and modifications as fall within the scope of the appended claims.

It will be understood that each of the elements described above, or two or more together, may also find a useful application in other types of constructions differing from the type described above.

While the invention has been illustrated and described as embodied in a refrigerant analyzer, it is not intended to be limited to that use or the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. Apparatus for measuring the index of refraction of a fluid, comprising:
a sample cell having walls defining a sample chamber and inlet and outlet openings for introducing a fluid sample into the sample chamber;
the sample cell further having first and second transparent windows;
a source of light positioned exterior of the sample cell to direct light into the sample chamber through the first window, through the sample chamber, and out of the sample chamber through the second window; and
an angle detector positioned exterior of the sample cell adapted to determine the angle of light exiting the sample cell with respect to the sample cell.

2. The apparatus of claim 1 with the sample cell being pressure-tight and adapted to measure the index of refraction of a volatile fluid.

3. The apparatus of claim 1 with the source of light being a laser.

4. The apparatus of claim 1 with the angle detector being a linear array of light-sensitive elements.

5. The apparatus of claim 1 with the sample cell and angle detector being fixed to opposing faces of a transparent, solid positioner.

6. Apparatus for measuring the index of refraction of a fluid, comprising:
a hollow sample cell having interior and exterior walls, with the interior walls defining a sample chamber;
the sample cell further having walls defining inlet and outlet openings through the interior and exterior walls for introducing a fluid sample into the sample chamber;
the sample cell further having first and second opposed, spaced-apart, transparent windows;
a laser positioned exterior of the sample cell opposite the first window;
the laser and first and second windows adapted and arranged such that laser light is directed into the sample cell through the first window, through the sample chamber, and out of the sample cell through the second window;
a transparent positioner connected to an exterior wall of sample cell and having a first face opposite the second window and a second face spaced apart and opposite from the first face; and
an angle detector connected to the second face of the transparent positioner adapted to determine the angle of the light exiting the sample cell with respect to the sample cell, the angle detector including a linear array of light-sensitive elements, the array adapted to generate an electrical signal indicative of light-sensitive elements illuminated by the laser light.

7. The apparatus of claim 6 including a computer electrically connected to the array adapted to calculate a value representing the index of refraction of a fluid in the sample chamber based on the electrical signal generated by the linear array.

8. The apparatus of claim 7 including a display electrically connected to the computer for visually indicating the value representing the index of refraction.

9. The apparatus of claim 6 with a transparent optical coupling fluid between the second window and the transparent positioner.

10. The apparatus of claim 9 with the second window, coupling fluid and transparent positioner having ever-increasing indices of refraction with each successive element, such that the resolution of the apparatus is increased with the distance between the sample cell and the positioner.

11. Apparatus for analyzing fluids, comprising:
a sample cell having walls defining a sample chamber and inlet and outlet openings for introducing a fluid sample into the sample chamber;
a first sensor for determining the index of refraction of the fluid sample; and
a second sensor for determining at least one additional physical characteristic of the fluid sample.

12. The apparatus of claim 11 with a computer adapted to identify the fluid in the fluid sample from the index of refraction and the additional physical characteristic.

13. Apparatus for analyzing fluids, comprising:
a sample cell having walls defining a sample chamber and inlet and outlet openings for introducing a fluid sample into the sample chamber;
a first sensor for determining the index of refraction of the fluid sample;
a second sensor for determining the temperature of the fluid sample; and
a third sensor for determining the pressure of the fluid sample.

14. The apparatus of claim 13 with a computer electrically connected to the first, second and third sensors and adapted to identify the fluid in the fluid sample by comparing the index of refraction, temperature and pressure determined by the first, second and third sensors with pre-determined relationship data for a plurality of different fluids.

15. The apparatus of claim 14 with a display electrically connected to the computer for displaying the identity of the fluid determined by the computer.

16. A method analyzing a fluid, comprising the steps of
introducing a sample of the fluid into a sample cell having walls defining a sample chamber;
determining the index of refraction of the fluid sample;
determining a second physical characteristic of the sample; and
identifying the fluid in the fluid sample by comparing the index of refraction and the second physical characteristic with known relationship data.

17. The method of claim 16 where the second physical characteristic of the sample is temperature.

18. The method of claim 16 where the second physical characteristic of the sample is pressure.

19. The method of claim 16 where a third physical characteristic is determined, and the step of identifying the fluid in the fluid sample includes comparing the index of refraction and the second and third physical characteristics with known relationship data.

20. The method of claim 19 including the step of varying one physical characteristic BM_{—}1_BM_{—}1_of the sample and taking a plurality of measurements, and the step of determining the identities and percentages of constituents of a fluid mixture.
